(19) United States
(12) Patent Application Publication
(10) Pub. No.: US 2024/0191077 A1
(43) Pub. Date: Jun. 13, 2024

(54) Hydrolytically Stable Polyarylene Sulfide Composition

(71) Applicant: Ticona LLC, Florence, KY (US)

(72) Inventors: Yuehua Yu, Cincinnati, OH (US); Christopher McGrady, Walton, KY (US)

(21) Appl. No.: 18/515,356

(22) Filed: Nov. 21, 2023

Related U.S. Application Data
(60) Provisional application No. 63/428,410, filed on Nov. 28, 2022.

(51) Int. Cl. C08L 81/04; C08K 9/08

(52) U.S. Cl. CPC C08L 81/04; C08K 9/08; C08K 2201/003; C08K 2201/019; C08L 2203/20

(57) ABSTRACT

A polymer composition hat comprises 100 parts by weight of a polymer matrix that includes at least one polyarylene sulfide and from about 30 parts by weight to about 120 parts by weight of inorganic fibers is provided. The polymer composition exhibits an initial tensile strength and an aged tensile strength after exposure to a solution containing 50 vol. % deionized water and 50 vol. % of ethylene glycol at a temperature of 135° C. for 1,000 hours. The ratio of the aged tensile strength to the initial tensile strength is about 0.8 or more.

### RELATED APPLICATION

The present application is based upon and claims priority to U.S. Provisional Patent Application Ser. No. 63/428, 140, having a filing date of Nov. 28, 2022, which is incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. Plastic materials are often employed in the electric vehicle for various electronic components, such as in high voltage connectors, power converter housings, battery assembly housings, inverters, busbars, twisted cables, individual sense lead wires, wire crimps, grommet moldings, quick connectors, tees, interconnects, guide rails, sealing rings (e.g., brushless direct current sealing rings, battery cell sealing rings, etc.), etc. Unfortunately, plastic materials, especially when reinforced with glass fibers, often used in such components exhibit poor mechanical characteristics (e.g., tensile strength and impact resistance) when exposed to moisture. This is particularly evident at elevated temperatures. As such, a need currently exists for a polymer composition that exhibits a higher degree of hydrolytic resistance at elevated temperatures.

### SUMMARY OF THE INVENTION

In accordance with one embodiment of the present invention, a polymer composition is disclosed that comprises 100 parts by weight of a polymer matrix that includes at least one polyarylene sulfide and from about 30 parts by weight to about 120 parts by weight of inorganic fibers. The polymer composition exhibits an initial tensile strength and an aged tensile strength after exposure to a solution containing 50 vol. % deionized water and 50 vol. % of ethylene glycol at a temperature of 135° C. for 1,000 hours. The ratio of the aged tensile strength to the initial tensile strength is about 0.8 or more.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates an electric vehicle including components that may incorporate a polymer composition as disclosed herein;

FIG. 2 illustrates one embodiment of a busbar as may incorporate a polymer composition as disclosed herein;

FIG. 3 illustrates a battery assembly that may employ components that may incorporate a polymer composition as disclosed herein;

FIG. 4 illustrates an electronic system as may include components that may incorporate a polymer composition as disclosed herein;

FIG. 5 illustrates a current sensor as may be included in an electronic system as in FIG. 4;

FIG. 6 illustrates an inverter system as may be present in an electric car including components that may incorporate a polymer composition as disclosed herein;

FIG. 7 is a perspective view of one embodiment of a connector that may incorporate a polymer composition as disclosed herein;

FIG. 8 is a plan view of the connector of FIG. 7 in which the first and second connector portions are disengaged;

FIG. 9 is a plan view of the connector of FIG. 7 in which the first and second connector portions are engaged;

FIG. 10 illustrates examples of components that may incorporate a polymer composition as disclosed herein;

FIG. 11 illustrates additional components that may incorporate a polymer composition as disclosed herein;

FIG. 12 illustrates a low temperature thermal loop as may include components that may incorporate a polymer composition as disclosed herein;

FIG. 13 illustrates a high temperature thermal loop as may include components that may incorporate a polymer composition as disclosed herein; and

FIG. 14 illustrates one embodiment of a coolant pump as may incorporate a polymer composition as disclosed herein.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a polymer matrix including at least one polyarylene sulfide and inorganic fibers. By selectively controlling the specific nature and relative concentration of the components of the composition, the present inventors have discovered that the resulting composition can exhibit a unique combination of properties that enables it to be readily employed in a wide variety of product applications (e.g., electric vehicle) even at relatively small part thickness values, such as about 4 millimeters or less, in some embodiments about from about 0.2 to about 3.2 millimeters, in some embodiments from about 0.4 to about 2.5 millimeters, and in some embodiments, from about 0.8 to about 2 millimeters.

The polymer composition may, for example, exhibit a tensile stress at break (i.e., strength) of from about 100 MPa to about 300 MPa, in some embodiments from about 120 MPa to about 250 MPa, in some embodiments from about 130 to about 220 MPa, and in some embodiments, from about 140 to about 200 MPa; a tensile break strain (i.e., elongation) of about 1% or more, in some embodiments from about 1.2% to about 8%, and in some embodiments, from about 1.5% to about 5%; and/or a tensile modulus of about 15,000 MPa or less, in some embodiments from about 1,000 MPa to about 12,000 MPa, in some embodiments from about 5,000 MPa to about 11,000 MPa. The tensile properties may be determined in accordance with ISO 527:2019 at a temperature of 23° C. The composition may also exhibit a flexural strength of about 20 MPa or more, in some embodiments from about 25 to about 200 MPa, in some embodiments from about 30 to about 150 MPa, and in some embodiments, from about 35 to about 100 MPa and/or a flexural modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The flexural properties may be determined in accordance with ISO 178:2019 at a temperature of 23° C. The polymer composition may also exhibit a high impact strength, which can provide enhanced flexibility for the resulting part. For example, the polymer composition may exhibit a notched Charpy impact strength of about 2 kJ/m² or more, in some embodiments from about 4 to about 40 kJ/m², and in some embodiments, from about 5 to about 20 kJ/m², as determined at a temperature of 23° C. in accordance with ISO 179-1:2010.

Notably, the present inventors have discovered that the polymer composition is not highly sensitive to the presence of aqueous coolant solutions at high temperatures. For example, the polymer composition may be placed into contact with a solution containing 50 vol. % deionized water and 50 vol. % of ethylene glycol at a temperature of about 100° C. or more, in some embodiments from about 110° C. to about 200° C., and in some embodiments, from about 120° C. to about 180° C.(e.g., 135° C.). Even when exposed to an aqueous coolant solution at such high temperatures, the mechanical properties (e.g., impact strength, tensile properties, etc.) may remain close to or even within the ranges noted above. The mechanical properties can also remain stable at such temperatures for a substantial period of time, such as for about 100 hours or more, in some embodiments from about 200 hours to about 3,000 hours, and in some embodiments, from about 250 hours to about 2,000 hours (e.g., 250, 500, 1,000, 1,500, or 2,000 hours).

After “aging” at 135° C. for 1,000 hours in the solution, for example, the ratio of the aged tensile strength to the initial tensile strength prior to such aging may be about 0.8 or more, in some embodiments about 0.85 or more, and in some embodiments, from about 0.9 to 1.0; the ratio of the aged tensile elongation to the initial tensile elongation prior to such aging may be about 0.7 or more, in some embodiments about 0.75 or more, and in some embodiments, from about 0.8 to 1.0; and/or the ratio of the aged tensile modulus to the initial tensile modulus prior to such aging may be about 0.8 or more, in some embodiments about 0.85 or more, and in some embodiments, from about 0.9 to 1.2. For example, the tensile strength after aging in the solution at 135° C. for 1,000 hours may be from about 80 MPa to about 300 MPa, in some embodiments from about 125 MPa to about 250 MPa, in some embodiments from about 130 to about 220 MPa, and in some embodiments, from about 140 to about 200 MPa, as determined at a temperature of about 23° C. in accordance with ISO 527:2019. Likewise, the tensile elongation after aging in the solution at 135° C. for 1,000 hours may, for instance, be about 0.7% or more, in some embodiments from about 1% to about 8%, in some embodiments from about 1.2% to about 5%, and in some embodiments, from about 1.4% to about 4%, as determined at a temperature of about 23° C. in accordance with ISO 527:2019. After aging in the solution at 135° C. for 1,000 hours, the ratio of the aged Charpy notched impact strength to the initial impact strength prior to such aging may also be about 0.6 or more, in some embodiments about 0.7 or more, and in some embodiments, from about 0.8 to 1.0. For example, the Charpy notched impact strength after aging in the solution at 135° C. for 1,000 hours may be about 1 kJ/m² or more, in some embodiments about 2 kJ/m² or more, in some embodiments from about 4 to about 20 kJ/m², and in some embodiments, from about 5 to about 15 kJ/m², as determined at a temperature of 23° C. in accordance with ISO Test No. 179-1:2010.

The polymer composition may also exhibit good heat resistance and flame retardancy. The melting temperature of the composition may, for instance, be from about 250° C. to about 440° C., in some embodiments from about 260° C. to about 400° C., and in some embodiments, from about 280° C. to about 380° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, range be about 260° C. or more, in some embodiments from about 260° C. to about 350° C., and in some embodiments, from about 265° C. to about 320° C., such as determined in accordance with ISO 75:2013 at a load of 1.8 MPa. Such high DTUL values can, among other things, allow the use of high speed and reliable surface mounting processes for mating the structure with other components of an electrical component. The flame retardant properties of the composition may likewise be characterized in accordance the procedure of Underwriter's Laboratory Bulletin 94 entitled “Tests for Flammability of Plastic Materials, UL94.” Several ratings can be applied based on the time to extinguish ((total flame time of a set of 5 specimens) and ability to resist dripping as described in more detail below. According to this procedure, for example, the composition may exhibit a V0 rating at a part thickness such as noted above (e.g., from about 0.4 to about 3.2 millimeters, e.g., 0.4, 0.8, or 1.6 millimeters), which means that it has a total flame time of about 50 seconds or less. To achieve a V0 rating, the composition may also exhibit a total number of drips of burning particles that ignite cotton of 0.

Various embodiments of the present invention will now be described in greater detail below.

### I. Polymer Composition

### A. Polymer Matrix

The polymer matrix typically constitutes from about 40 wt. % to about 90 wt. %, in some embodiments from about 45 wt. % to about 90 wt. %, and in some embodiments, from about 50 wt. % to about 70 wt. % of the polymer composition. The polymer matrix contains at least one polyarylene sulfide. For example, polyarylene sulfides typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

The polyarylene sulfide(s) generally have repeating units of the formula:

—[(Ar¹)ₙ—X]ₘ——[(Ar²)ᵢ—Y]ⱼ—[(Ar³)ₖ—Z]ₗ—[(Ar⁴)ₒ—W]ₚ—

wherein,
Ar¹, Ar², Ar³, and Ar⁴ are independently arylene units of 6 to 18 carbon atoms;
W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and
n, m, i, j, k, l, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthalene, anthracene and phenanthrene. The polyarylene sulfide typically includes more than about 30 mol. %, more than about 50 mol. %, or more than about 70 mol. % arylene sulfide (—S—) units. For example, the polyarylene sulfide may include at least 85 mol. % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

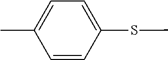

and segments having the structure of formula:

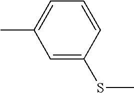

or segments having the structure of formula:

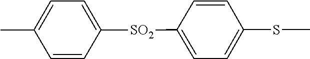

The polyarylene sulfide(s) may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any optional impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′- morpholinodithio)benzothiazole, etc., as well as mixtures thereof.

The melt flow rate of a polyarylene sulfide incorporated in a composition can be from about 100 to about 800 grams per 10 minutes (“g/10 min”), in some embodiments from about 200 to about 700 g/10 min, and in some embodiments, from about 300 to about 600 g/10 min, as determined in accordance with ISO 1133:2011 at a load of 5 kg and temperature of 316° C.

### B. Inorganic Fibers

Inorganic fibers are also employed in the polymer composition to improve the thermal and mechanical properties of the composition. The inorganic fibers typically have a high degree of tensile strength relative to their mass. For example, the ultimate tensile strength of the fibers (determined in accordance with ASTM D822/D822M-13 (2018)) is typically from about 1,000 to about 15,000 Megapascals (“MPa”), in some embodiments from about 2,000 MPa to about 10,000 MPa, and in some embodiments, from about 3,000 MPa to about 6,000 MPa. Further, although the fibers may have a variety of different sizes, fibers having a certain size can help improve the mechanical properties of the resulting polymer composition. The inorganic fibers may, for example, have a nominal diameter of from about 5 micrometers to about 40 micrometers, in some embodiments from about 6 micrometers to about 30 micrometers, in some embodiments from about 8 micrometers to about 20 micrometers, and in some embodiments from about 9 micrometers to about 15 micrometers. The fibers (after compounding) may also have a relatively high aspect ratio (average length (μm) divided by nominal diameter (μm)), such as about 2 or more, in some embodiments from about 4 to about 100, in some embodiments from about 5 to about 50, and in some embodiments, from about 8 to about 40 are particularly beneficial. Such fibers may, for instance, have a volume average length (after compounding) of about 10 micrometers or more, in some embodiments about 25 micrometers or more, in some embodiments from about 50 micrometers or more to about 800 micrometers or less, and in some embodiments from about 60 micrometers to about 500 micrometers. The relative amount of the fibers may also be selectively controlled to help achieve the desired mechanical and thermal properties without adversely impacting other properties of the composition, such as its flowability. The inorganic fibers may, for instance, constitute from about 30 to about 120 parts by weight, in some embodiments from about 40 to about 110 parts by weight, and in some embodiments, from about 50 to about 100 parts by weight per 100 parts by weight of the polymer matrix. For example, the inorganic fibers may constitute from about 20 wt. % to about 60 wt. %, in some embodiments from about 25 wt. % to about 55 wt. %, and in some embodiments, from about 30 wt. % to about 50 wt. % of the polymer composition.

In addition to the size, strength, and relative concentration, the composition of the inorganic fibers may also be selectively controlled to achieve better hydrolytic stability at high temperatures. Generally speaking, the inorganic fibers may be formed from materials that are generally insulative in nature, such as glass, ceramics (e.g., alumina or silica), etc. Glass fibers are particularly suitable, such as E-glass, E-CR glass, A-glass, C-glass, D-glass, AR-glass, R-glass, S1-glass, S2-glass, etc., as well as mixtures of any of the foregoing. Glass fibers that are generally free of boron (e.g., E-CR glass fibers) are particularly suitable. In certain embodiments, the glass fibers may include silica (SiO₂), alumina (Al₂O₃), and oxides of calcium and magnesium (e.g., CaO, MgO, etc.), but are generally free of boron and optionally fluorides. For example, the glass fibers may contain boron in a concentration of about 1 wt. % or less, in some embodiments about 0.5 wt. % or less, in some embodiment about 0.1 wt. % or less (e.g., 0 wt. %), relative to the total weight of the glass fibers. The glass fibers may likewise contain fluorides in a concentration of about 0.5 wt. % or less, in some embodiments about 0.2 wt. % or less, in some embodiment about 0.01 wt. % or less (e.g., 0 wt. %), relative to the total weight of the glass fibers. Boron concentration and fluoride concentration can be measured by inductively coupled plasma-atomic emission spectrometry. In the absence of boric oxide, the glass fibers may further include titanium dioxide (TiO₂) to reduce melt viscosity. For example, the concentration of titanium in the glass fibers may be about 0.1 wt. % to about 1 wt. %, and in some embodiments, from about 0.15 wt. % to about 0.5 wt. % of the total weight of the glass fibers. Besides titanium dioxide, the glass fibers can further include potassium oxide (K₂O) and/or lithium oxide (Li₂O) as fluxing agents. For example, the concentration of potassium in the glass fibers may be about 0.2 wt. % to about 1 wt. %, and in some embodiments, from about 0.3 wt. % to about 0.5 wt. % of the total weight of the glass fibers. The concentration of lithium in the glass fibers may also be about 0.1 wt. % to about 1 wt. %, and in some embodiments, from about 0.2 wt. % to about 0.5 wt. % of the total weight of the glass fibers. The glass fibers may also have a relatively low amount of sodium oxide (Na₂O). For example, the concentration of sodium in the glass fibers may be about 0.1 wt. % to about 1 wt. %, and in some embodiments, from about 0.2 wt. % to about 0.5 wt. % of the total weight of the glass fibers. Titanium, potassium, lithium, and sodium concentrations can be measured by ICP-AES. In one particular embodiment, the glass fibers may contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, magnesium oxide in an amount of from about 8.5 wt. % to about 12.5 wt. %, and optionally sodium oxide, potassium oxide, lithium oxide, and/or titanium oxide. Other oxides may also be employed, such as iron oxide (Fe₂O₃).

If desired, the inorganic fibers may contain a sizing composition coated thereon to help improve hydrolytic resistance. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can enhance resistance to hydrolysis. Such organosilane compounds may, for instance, constitute from about 2 wt. % to about 40 wt. %, in some embodiments from about 2.5 wt. % to about 20 wt. %, and in some embodiments, from about 5 wt. % to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt, as well as reduce the hydrophilicity of the surface of the fibers believed to contribute to resistance to hydrolysis. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc .; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl) amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

In addition to an organosilane compound, the sizing composition may also contain one or more functionalized compounds that may be crosslinked to form a three-dimensional polymer network that can further enhance the hydrolytic resistance of the fibers. When employed, such functionalized compounds may constitute from about 5 wt. % to about 90 wt. %, in some embodiments from about 10 wt. % to about 80 wt. %, and in some embodiments, from about 15 wt. % to about 70 wt. % of the solids content of the sizing composition (i.e., excluding water). In one embodiment, for instance, the functionalized compound may be a blocked isocyanate. As used herein, the term “blocked isocyanate” refers to an isocyanate in which one or more of the isocyanate groups of an organic polyisocyanate have been reversibly reacted with a blocking agent. In this manner, the resulting blocked (partially or fully) isocyanate groups are stable to active hydrogens at ambient temperature but can become deblocked at elevated temperatures so that they are reactive with active hydrogens, such as, for example, at temperatures between about 90° C. to about 210° C., in some embodiments between about 105° C. to about 180° C., and in some embodiments, between about 125° C. to about 170° C. Representative examples of suitable organic polyisocyanates include aliphatic isocyanates (e.g., trimethylene diisocyanate, tetramethylene diisocyanate, hexamethylene diisocyanate, butylidene diisocyanate, etc.); (cyclo)aliphatic isocyanates (e.g., isophorone diisocyanate (IPDI), 4,4′-diisocyanato-dicyclohexylmethane (HMDI), etc.); aromatic isocyanates (e.g., p-phenylene diisocyanate); aliphatic-aromatic isocyanates (e.g., 4,4′-diphenylene methane diisocyanate, 2,4- or 2,6-tolylene diisocyanate, etc.); as well as mixtures thereof. Representative examples of suitable blocking agents include, but are not limited to, oximes, such as methyl ethyl ketoxime, acetone oxime and cyclohexanone oxime; lactams, such as epsilon-caprolactam; alcohols; malonic esters; alkyl acetoacetates, triazoles; pyrazoles; phenols; amines, such as benzyl t-butylamine; as well as mixtures thereof. In one embodiment, the blocked isocyanate is a blocked cycloaliphatic polyisocyanate.

The functionalized compound may also include polymers that contain an anhydride and/or carboxylic functionality. Examples of such polymers may include, for instance, a copolymer of ethylene-maleic anhydride, butadiene-maleic anhydride, isobutylene-maleic anhydride acrylate-maleic anhydride, polyacrylic acid, etc. When employed, such anhydride- and/or carboxylic-functionalized polymers may constitute from about 5 wt. % to about 60 wt. %, in some embodiments from about 10 wt. % to about 40 wt. %, and in some embodiments, from about 15 wt. % to about 30 wt. % of the solids content of the sizing composition (i.e., excluding water). Other functionalized polymers may also be employed, either alone or in combination with polymers that contain an anhydride and/or carboxylic functionality. In certain embodiments, for example, an epoxy-functionalized polymer may be employed, such as epoxy phenol novolac (EPN), epoxy cresol novolac (ECN), etc. When employed, such epoxy-functionalized polymers may constitute from about 30 wt. % to about 90 wt. %, in some embodiments from about 40 wt. % to about 80 wt. %, and in some embodiments, from about 50 wt. % to about 70 wt. % of the solids content of the sizing composition (i.e., excluding water). In certain embodiments, combinations of such functionalized polymers may also be employed. In fact, it is believed that a dense crosslinked sheath can formed around the inorganic fibers by reaction of epoxy groups with maleic anhydride and/or carboxylic groups.

Apart from organosilane and functionalized compounds, the sizing composition may also contain a film-forming agent that can help protect the fibers from damage during processing and promote compatibility of the fibers with the polymer matrix. Particularly suitable film forming agents are polymers, such as polyurethanes, (meth)acrylate polymers, epoxy resin emulsions (e.g., based on epoxy bisphenol A or epoxy bisphenol F), epoxy ester resins, epoxy urethane resins, polyamides, etc., as well as mixtures of any of the foregoing. In one particular embodiment, for example, the film forming agent may include a polymer that is also functionalized, such as a polymer that includes a blocked isocyanate functionality as described above. Examples of such functionalized film-forming agents may include polyester-based and polyether-based polyurethanes that include a blocked isocyanate. When employed, such film forming agents may constitute from about 0.1 wt. % to about 50 wt. %, in some embodiments from about 1 wt. % to about 40 wt. %, and in some embodiments, from about 5 wt. % to about 30 wt. % of the solids content of the sizing composition (i.e., excluding water). Other additives may also be employed in the sizing composition, such as pH adjusters, lubricants, antistatic agents, antifoaming agents, crosslinking agents, etc.

The sizing composition may be applied to the surface of the inorganic fibers in a variety of different ways. For example, the sizing composition may be applied as the fibers are formed out of a bushing. The entire composition may also be applied to the fibers in a single step, or one or more components of the sizing composition may be applied separately. In one embodiment, for example, a two-stage application process may be employed in which a polymer containing an anhydride and/or carboxylic acid functionality is applied in a first stage and a polymer containing an epoxy functionality is applied in a second stage. In this manner, the polymers may be crosslinked together only after application to the fiber surface. Other components of the sizing composition may be applied separately or in combination with one or both of the polymers. Notwithstanding the particular process employed, one or more solvents (e.g., water) may be added to the components of the sizing composition during application to aid in the coating process. Once coated, the fibers may be dried to remove the solvent. In this regard, the moisture content of the coated fibers is typically about 0.5 wt. % or less, in some embodiments about 0.2 wt. % or less, and in some embodiments about 0.1 wt. % or less. Likewise, the amount of the sizing composition employed is typically from about 0.3 wt. % to about 1.2 wt. %, in some embodiments from about 0.4 wt. % to about 1 wt. %, and in some embodiments, from about 0.5 wt. % to about 0.8 wt. % based on the total weight of the coated fibers.

### C. Organosilane Compound

In addition to the components noted above, the polymer composition may also contain a variety of other optional components to help improve its overall properties. In one embodiment, for instance, an organosilane compound may be employed in the polymer composition, such as in an amount of from about 0.1 to about 8 parts, in some embodiments from about 0.3 to about 5 parts, and in some embodiments, from about 0.5 to about 3 parts by weight per 100 parts by weight of the polyarylene sulfide(s). For example, organosilane compounds can constitute from about 0.01 wt. % to about 3 wt. %, in some embodiments from about 0.02 wt. % to about 2 wt. %, and in some embodiments, from about 0.05 to about 1 wt. % of the polymer composition.

The organosilane compound may be the same or different than the organosilane compound optionally employed in the sizing composition for the inorganic fibers. In one embodiment, for example, the organosilane compound may be an alkoxysilane, such as described above. Some representative examples of alkoxysilane compounds that may be employed include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

### D. Other Optional Components

Although by no means required, an impact modifier may also be employed within the polymer composition. When employed, the impact modifier(s) may constitute from about 1 to about 20 parts, in some embodiments from about 2 to about 15 parts, and in some embodiments, from about 5 to about 10 parts by weight per 100 parts by weight of the polyarylene sulfide(s). For example, the impact modifiers may constitute from about 0.1 wt. % to about 20 wt. %, in some embodiments from about 0.5 wt. % to about 15 wt. %, and in some embodiments, from about 1 wt. % to about 10 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

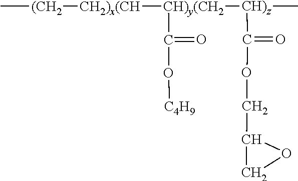

wherein, x, y, and z are 1 or greater.

The relative portion of the monomeric component(s) may be selected to achieve a balance between epoxy-reactivity and melt flow rate. More particularly, high epoxy monomer contents can result in good reactivity with the polyarylene sulfide, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-20 at a load of 2.16 kg and temperature of 190° C.

If desired, additional impact modifiers may also be employed in combination with the epoxy-functional impact modifier. For example, the additional impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the PEBAX™ trade name. The polyamide blocks may be derived from a copolymer of a diacid component and a diamine component or may be prepared by homopolymerization of a cyclic lactam. The polyether block may be derived from homo- or copolymers of cyclic ethers such as ethylene oxide, propylene oxide, and tetrahydrofuran.

A siloxane polymer may also be employed in the polymer composition. Such siloxane polymer(s) typically constitute from about 0.05 to about 10 parts, in some embodiments from about 0.1 to about 8 parts, and in some embodiments, from about 0.5 to about 5 parts by weight per 100 parts by weight of the polyarylene sulfide(s). For example, siloxane polymer(s) may constitute from about 0.05 wt. % to about 15 wt. %, in some embodiments from about 0.5 wt. % to about 10 wt. %, and in some embodiments, from about 1 wt. % to about 8 wt. % of the polymer composition.

The siloxane polymer can, among other things, improve the processing of the composition, such as by providing better mold filling, internal lubrication, mold release, etc. Further, it is also believed that the siloxane polymer is less likely to migrate or diffuse to the surface of the composition, which further minimizes the likelihood of phase separation and further assists in dampening impact energy. The siloxane polymer generally has a high molecular weight, such as a weight average molecular weight of about 100,000 grams per mole or more, in some embodiments about 200,000 grams per mole or more, and in some embodiments, from about 500,000 grams per mole to about 2,000,000 grams per mole. The siloxane polymer may also have a relatively high kinematic viscosity at 25° C., such as about 10,000 centistokes or more, in some embodiments about 30,000 centistokes or more, and in some embodiments, from about 50,000 to about 50×10⁶ centistokes, such as from about 1×10⁶ to 50×10⁶ centistokes. The viscosity of a siloxane polymer can be determined according to ASTM D445-21.

Any of a variety of high molecular weight siloxane polymers may generally be employed in the polymer composition. A high molecular weight siloxane polymer generally includes siloxane-based monomer residue repeating units. As used herein, “siloxane” denotes a monomer residue repeat unit having the structure:

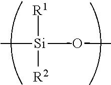

where R¹ and R² are independently hydrogen or a hydrocarbyl moiety, which is known as an “M” group in silicone chemistry.

The silicone may include branch points such as

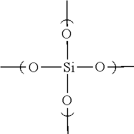

which is known as a “Q” group in silicone chemistry, or

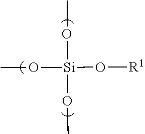

which is known as “T” group in silicone chemistry.

As used herein, the term “hydrocarbyl” denotes a univalent group formed by removing a hydrogen atom from a hydrocarbon (e.g., alkyl groups, such as ethyl, or aryl groups, such as phenyl). In one or more embodiments, a siloxane monomer residue can be any dialkyl, diaryl, dialkaryl, or diaralkyl siloxane, having the same or differing alkyl, aryl, alkaryl, or aralkyl moieties. In an embodiment, each of R¹ and R² is independently a C₁ to C₂₀, C₁ to C₁₂, or C₁ to C₆ alkyl (e.g., methyl, ethyl, propyl, butyl, etc.), aryl (e.g., phenyl), alkaryl, aralkyl, cycloalkyl (e.g., cyclopentyl), arylenyl, alkenyl, cycloalkenyl (e.g., cyclohexenyl), alkoxy (e.g., methoxy), etc., as well as combinations thereof. In various embodiments, R¹ and R² can have the same or a different number of carbon atoms. In various embodiments, the hydrocarbyl group for each of R¹ and R² is an alkyl group that is saturated and optionally straight-chain. Additionally, the alkyl group in such embodiments can be the same for each of R¹ and R² of a polymer chain. Non-limiting examples of alkyl groups suitable for use in R¹ and R² include methyl, ethyl, 1-propyl, 2-propyl, 1-butyl, isobutyl, t-butyl, or combinations of two or more thereof.

Additionally. the siloxane polymer can contain various terminating groups as an R¹ and/or R² group, such as vinyl groups, hydroxyl groups, hydrides, isocyanate groups, epoxy groups, acid groups, halogen atoms, alkoxy groups, acyloxy groups, ketoximate groups, amino groups, amido groups, acid amido groups, amino-oxy groups, mercapto groups, alkenyloxy groups, alkoxyalkoxy groups, or aminoxy groups as well as combinations thereof. Additionally, a polymer composition can include a mixture of two or more siloxane polymers.

In some embodiments, a high molecular weight siloxane polymer can be proved by copolymerizing multiple siloxane polymers having a low weight average molecular weight (e.g., a molecular weight of less than 100,000 grams per mole) with polysiloxane linkers. In one particular embodiment, for instance, the resin may be formed by copolymerizing one or more low molecular siloxane polymer(s) with a linear polydiorganosiloxane linker, such as described in U.S. Pat. No. 6,072,012 to Juen, et al. A substantially linear polydiorganosiloxane linker may have the following general formula:

(R³₍₃₋ₚ₎R⁴ₚSiO_{1/2})(R³₂SiO_{2/2})ₓ((R³R⁴SiO_{2/2})(R³₂SiO_{2/2})ₓ)_{y}(R³₍₃₋ₚ₎R⁴ₚSiO_{1/2})

wherein,
each R³ is a monovalent group independently selected from the group consisting of alkyl, aryl, and arylalkyl groups;
each R⁴ is a monovalent group independently selected from the group consisting of hydrogen, hydroxyl, alkoxy, oximo, alkyloximo, and aryloximo groups, wherein at least two R⁵ groups are typically present in each molecule and bonded to different silicon atoms;
p is 0, 1, 2, or 3;
x ranges from 0 to 200, and in some embodiments, from 0 to 100; and
y ranges from 0 to 200, and in some embodiments, from 0 to 100.

In certain embodiments, the siloxane polymer may be provided in the form of a masterbatch that includes a carrier resin. The carrier resin may, for instance, constitute from about 0.05 wt. % to about 15 wt. %, in some embodiments from about 0.1 wt. % to about 10 wt. %, and in some embodiments, from about 0.5 wt. % to about 8 wt. % of the polymer composition. Any of a variety of carrier resins may be employed, such as polyolefins (ethylene polymer, propylene polymers, etc.), polyamides, etc. In one embodiment, for example, the carrier resin is an ethylene polymer. The ethylene polymer may be a copolymer of ethylene and an α-olefin, such as a C₃-C₂₀ α-olefin or C₃-C₁₂ α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %. The density of the ethylene polymer may vary depending on the type of polymer employed, but generally ranges from about 0.85 to about 0.96 grams per cubic centimeter (g/cm³). Polyethylene “plastomers”, for instance, may have a density in the range of from about 0.85 to about 0.91 g/cm³. Likewise, “linear low density polyethylene” (LLDPE) may have a density in the range of from about 0.91 to about 0.940 g/cm³; “low density polyethylene” (LDPE) may have a density in the range of from about 0.910 to about 0.940 g/cm³; and “high density polyethylene” (HDPE) may have density in the range of from about 0.940 to about 0.960 g/cm³, such as determined in accordance with ASTM D792. Some non-limiting examples of high molecular weight siloxane polymer masterbatches that may be employed include, for instance, those available from Dow Corning under the trade designations MB50-001, MB50-002, MB50-313, MB50-314 and MB50-321.

The polymer composition may also contain a heat stabilizer. By way of example, the heat stabilizer can be a phosphite stabilizer, such as an organic phosphite. For example, suitable phosphite stabilizers include monophosphites and diphosphites, wherein the diphosphite has a molecular configuration that inhibits the absorption of moisture and/or has a relatively high Spiro isomer content. For instance, a diphosphite stabilizer may be selected that has a spiro isomer content of greater than 90%, such as greater than 95%, such as greater than 98%. Specific examples of such diphosphite stabilizers include, for instance, bis(2,4-dicumylphenyl)pentaerythritol diphosphite, bis(2,4-di-t-butylphenyl)pentaerythritol diphosphite, distearyl pentaerythritol diphosphite, mixtures thereof, etc. When employed, heat stabilizers typically constitute from about 0.1 wt. % to about 3 wt. %, and in some embodiments, from about 0.2 wt. % to about 2 wt. % of the composition.

A nucleating agent may also be employed to further enhance the crystallization properties of the composition. One example of such a nucleating agent is an inorganic crystalline compound, such as boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), and so forth. Boron nitride (BN) has been found to be particularly beneficial when employed in the polymer composition of the present invention. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form is particularly suitable due to its stability and softness.

If desired, a crosslinking system may also be employed in combination with any optional impact modifier(s) to help further improve the strength and flexibility of the composition under a variety of different conditions. In such circumstances, a crosslinked product may be formed from a crosslinkable polymer composition that contains the polyarylene sulfide(s), in conjunction with one or more of impact modifier(s), siloxane polymer(s), filler(s) and crosslinking system as well as any other additives. When employed, such a crosslinking system, which may contain one or more crosslinking agents, typically constitutes from about 0.1 to about 15 parts, in some embodiments from about 0.2 to about 10 parts, and in some embodiments, from about 0.5 to about 5 parts per 100 parts of the polyarylene sulfide(s), as well as from about 0.05 wt. % to about 15 wt. %, in some embodiments from about 0.1 wt. % to about 10 wt. %, and in some embodiments, from about 0.2 wt. % to about 5 wt. % of the polymer composition. Through the use of such a crosslinking system, the compatibility and distribution of the polyarylene sulfide and impact modifier can be significantly improved. For example, the impact modifier is capable of being dispersed within the polymer composition in the form of discrete domains of a nano-scale size. For example, the domains may have an average cross-sectional dimension of from about 1 to about 1000 nanometers, in some embodiments from about 5 to about 800 nanometers, in some embodiments from about 10 to about 500 nanometers. The domains may have a variety of different shapes, such as elliptical, spherical, cylindrical, plate-like, tubular, etc. Such improved dispersion can result in either better mechanical properties or allow for equivalent mechanical properties to be achieved at lower amounts of impact modifier.

Any of a variety of different crosslinking agents may generally be employed within the crosslinking system. In one embodiment, for instance, the crosslinking system may include a metal carboxylate. Without intending to be limited by theory, it is believed that the metal atom in the carboxylate can act as a Lewis acid that accepts electrons from the oxygen atom located in a functional group (e.g., epoxy functional group) of the impact modifier. Once it reacts with the carboxylate, the functional group can become activated and can be readily attacked at either carbon atom in the three-membered ring via nucleophilic substitution, thereby resulting in crosslinking between the chains of the impact modifier. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the polymer composition.

The crosslinking system may also employ a crosslinking agent that is “multi-functional” to the extent that it contains at least two reactive, functional groups. Such a multi-functional crosslinking reagent may serve as a weak nucleophile, which can react with activated functional groups on the impact modifier (e.g., epoxy functional groups). The multi-functional nature of such molecules enables them to bridge two functional groups on the impact modifier, effectively serving as a curing agent. The multi-functional crosslinking agents generally include two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

When employed, multi-functional crosslinking agents typically constitute from about 50 wt. % to about 95 wt. %, in some embodiments from about 60 wt. % to about 90 wt. %, and in some embodiments, from about 70 wt. % to about 85 wt. % of the crosslinking system, while the metal carboxylates typically constitute from about 5 wt. % to about 50 wt. %, in some embodiments from about 10 wt. % to about 40 wt. %, and in some embodiments, from about 15 wt. % to about 30 wt. % of the crosslinking system. For example, the multi-functional crosslinking agents may constitute from about 0.1 wt. % to about 10 wt. %, in some embodiments from about 0.2 wt. % to about 5 wt. %, and in some embodiments, from about 0.5 wt. % to about 3 wt. % of the polymer composition. Of course, in certain embodiments, the composition may be generally free of multi-functional crosslinking agents, or the crosslinking system may be generally free of metal carboxylates.

Still other components that can be included in the composition may include, for instance, nucleating agents, particulate fillers (e.g., talc, mica, etc.), pigments (e.g., black pigments), colorants, antioxidants, stabilizers, surfactants, lubricants, and other materials added to enhance properties and processability.

In one embodiment, for example, the polymer composition may contain a nucleating agent, such as a boron-containing particles. When employed, such particles may constitute from about 0.01 wt. % to about 5 wt. %, in some embodiments from about 0.02 wt. % to about 2 wt. %, and in some embodiments, from about 0.05 wt. % to about 1 wt. % of the polymer composition. The boron-containing particles may exhibit a surprisingly high graphitization index such as greater than about 4, greater than about 5, or greater than about 6, in some embodiments from about 6 and about 10, and in some embodiments, from about 7 and about 9. The graphitization index (also commonly termed graphite index) is a parameter that describes the structural quality of the boron-containing particles. Boron-containing particles such as boron nitride exist in several crystalline forms including hexagonal, which is similar to graphite in structure; cubic, which is analogous to diamond; and wurtzite, which is similar to lonsdaleite (also called hexagonal diamond). Following formation, the boron-containing particles can have different degrees of crystallization. To measure this degree of crystallization, the structural figure of merit termed graphitization index has been developed. The graphitization index is derived from x-ray diffraction and is the ratio of the area under [(100)+(101)] peaks to the area under the (102) peak. The graphitization index describes the degree of order in the stacking of the layers along the c-axis of the material. The graphitization index can vary greatly, for instance from about 1 for well-ordered, highly crystalline particles up to about 50 for the so-called turbostratic particles, in which the layers show random rotations and translation about the normal.

In conjunction with low crystallinity, the boron-containing nucleating agent can also have a small particle size. For instance, the nucleating agent can have an average particle size of less than about 10 micrometers, in some embodiments from about 0.5 to about 10 micrometers, in some embodiments from about 1 micrometer to about 9 micrometers, and in some embodiments, from about 2 to about 8 micrometers, such as determined according to sedimentation techniques, laser diffraction methods, or any other suitable technique. For example, particle size distribution can be determined according to a standard testing method such as ASTM D4464 or ASTM B822. The nucleating agent can also have a large specific surface area. The specific surface area can be, for example, greater than about 15 m2/g, greater than about 17 m²/g, or greater than about 19 m²/g. In one embodiment, the specific surface area can be quite large, for instance greater than about 30 m²/g. The specific surface area can be determined according to standard methods such as by the physical gas adsorption method (B.E.T. method) with nitrogen as the adsorption gas, as is generally known in the art and described by Brunauer, Emmet, and Teller (J. Amer. Chem. Soc., vol. 60, February, 1938, pp. 309-319). The combination of small particle size and large specific surface area can provide a boron-containing nucleating agent that has a ratio of average particle size to specific surface area of between about 0.001 and about 1, for instance between about 0.01and about 0.8, or between about 0.02 and about 0.25. The nucleating agent particles can have any overall shape. For example, the nucleating agent can include high aspect ratio particles having a needle-like or plate-like structure. The boron-containing nucleation agent can also be in the form of aggregated particles, in which the individual high aspect ratio particles are aggregated together with no particular orientation or in a highly ordered fashion, for instance via weak chemical bonds such as Van der Waals forces. Non-aggregated larger particles can also be utilized. For instance particles including a large number of stacked plate-like primary particles can be utilized as well as particles in which the primary structure is not evident, such as granulated or pulverized particles formed of larger sintered bodies.

Suitable boron-containing nucleating agents may include any boron-containing material as is generally known in the art that may be provided with the disclosed characteristics. By way of example, boron-containing nucleating agent materials can include, without limitation, boron nitride, sodium tetraborate, potassium tetraborate, calcium tetraborate, etc., as well as mixtures thereof. Boron nitride (BN) has been found to be particularly beneficial. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form may be utilized in one embodiment due to its stability and softness.

### II. Melt Processing

The manner in which the polyarylene sulfide, inorganic fibers, and other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The polymer composition may also exhibit a relatively low melt viscosity, such as about 30 kP or less, in some embodiments about 20 kP or less, in some embodiments about 10 kP or less, in some embodiments about 5 kP or less, and in some embodiments, from about 2 to about 50 kP, as determined in accordance with ISO 11443:2021 at a temperature of about 310° C. and at a shear rate of 400 s⁻¹.

### III. Formed Component

A variety of different components may be formed using the polymer composition described herein. Moreover, a component may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

### IV. Product Applications

As previously mentioned, the disclosed polymer compositions are particularly beneficial for use in components of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 1, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells.

In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 36 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

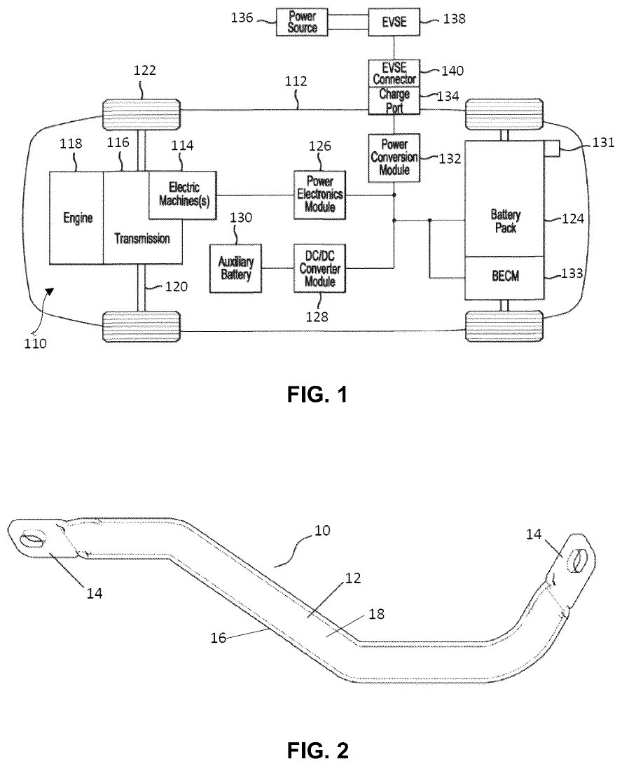

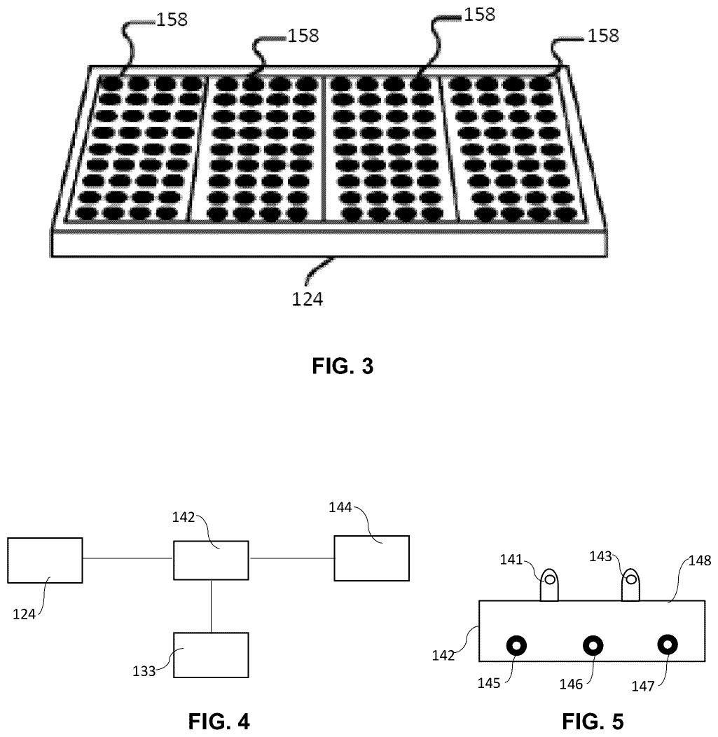

The polymer composition described herein can be included in various components of an electric vehicle as illustrated in FIG. 1. For instance, a busbar, one example of which is illustrated in FIG. 2, may be used to electrically connect individual cells of the battery assembly 124. Referring to FIG. 3, for example, the battery assembly 124 can include a number of battery cells 158. The battery cells 158 may be stacked side-by-side to construct a grouping of battery cells, sometimes referred to as a battery array. In one embodiment, the battery cells 158 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. Each battery cell 158 includes a positive terminal (designated by the symbol (+)) and a negative terminal (designed by the symbol (−)). The battery cells 158 are arranged such that each battery cell 158 terminal is disposed adjacent to a terminal of an adjacent battery cell 158 having an opposite polarity. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle. For example, some embodiments may use the 6831 NCR 18650 battery cell from Panasonic®, or some variation on the 18650 form-factor of 6.5 cm×1.8 cm and approximately 45 g.

The manner in which a busbar connects to individual battery cells of a battery assembly 124, such as shown in FIG. 3, may vary as is known in the art. Referring to FIG. 2, one embodiment of a busbar 10 is shown that includes a conductive body 12. The body 12 includes a conductive material 18, such as copper, aluminum, aluminum alloy, etc., and can generally be in the form of a solid bar, hollow tube, and so forth. The busbar 10 includes a connector portion 14 at either end that is configured to mate with respective terminations of two or more batteries. An insulative portion 16 (e.g., coating or molded material) that includes the polymer composition as described herein may cover a portion of the conductive material of the body 12. To form the busbar 10, the insulative portion 16 can be applied to the surface of the conductive material 18. For instance, a bar or tube of the conductive material 18 can be inserted into a pre-formed tube of the insulating coating 16, e.g., an extruded tube sized and cut to the correct proportions, following which the busbar 10 can be shaped to any suitable form. In another embodiment, the insulating coating can be applied to the surface of the conductive material 18 in the melt, and can solidify on the surface of the conductive material in the applied areas.

Of course, a busbar may be provided in any suitable shape and size. For instance, a busbar may be used as a template for placing the individual battery cells so that they are uniform in each battery assembly manufactured. In such an embodiment, a busbar may hold individual batteries of a battery assembly 124 in place during the manufacturing process and thermal padding or injection-housings, which can be formed of a polymer composition as described herein, can be added without causing the individual battery cells to shift out of position.

Apart from busbars, other components may also employ the polymer composition of the present invention. For instance, FIG. 4 presents a block diagram of battery electronics of an electric vehicle 112. The illustrated battery electronics system includes a battery assembly 124 and a current sensor 142. As shown, current sensor 142 is connected between battery assembly 124 and load/source 144. The current sensor 142 can be configured to measure the current flowing from the battery assembly 124 to the load/source 144 when load/source 144 is a load such as one or more electric machines 114. Likewise, current sensor 142 can be configured to measure the current flowing to battery assembly 124 from load/source 144 when the load/source 144 is a source such as an external power source 136. The (BECM) 133 can be configured to power current sensor 142 to enable its operation. The BECM 133 can further be configured to read an output generated by current sensor 142 which is indicative of the current flowing between battery assembly 124 and load/source 144.

FIG. 5 illustrates one embodiment of a current sensor 142. A current sensor 142 can include a current in port 141 and a current out port 143 as well as standard ground 145, voltage at common collector (VCC) 146, and output port(s) 147. The current sensor 142 can also include a housing 148 that includes the polymer composition as described that can house other components of the current sensor 142, e.g., resistors, capacitors, converters, processing chips, etc.

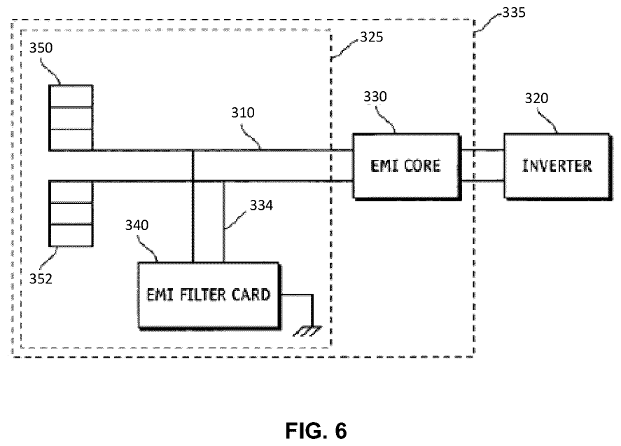

Another component of an electric vehicle as may incorporate the polymer compositions as described is an inverter system, one exemplary embodiment of which is illustrated in FIG. 6. The system includes an inverter module 320 and an interconnection system 335. The interconnection system 335 includes an Electromagnetic Interference (EMI) core 330 and an EMI filter apparatus 325. The inverter module 320 is coupled to the interconnection system 335 by a pair of bus bars 310. The EMI core 330 is located between the EMI filter apparatus 325 and the inverter module 320 and is in communication with the bus bars 310. The EMI filter apparatus 325 includes an EMI filter card 340 and a pair of bolts 350, 352 which include a positive terminal (+) bolt 350 and a negative terminal (−) bolt 352 for coupling to a power source, e.g., the battery assembly 124. The EMI core 330 is coupled to the bolts 350, 352 by the bus bars 310. The EMI filter card 340 is also coupled between ground and the bus bars 310 via a pair of wires 334. An inverter module 320 includes a number of transistors (not shown). Transistors in an inverter module 320 switch on and off relatively rapidly (e.g., 5 to 20 kHz). This switching tends to generate electrical switching noise. The electrical switching noise should ideally be contained inside the inverter module 320 and prevented from entering the rest of the electrical system to prevent interference with other electrical components in the vehicle.

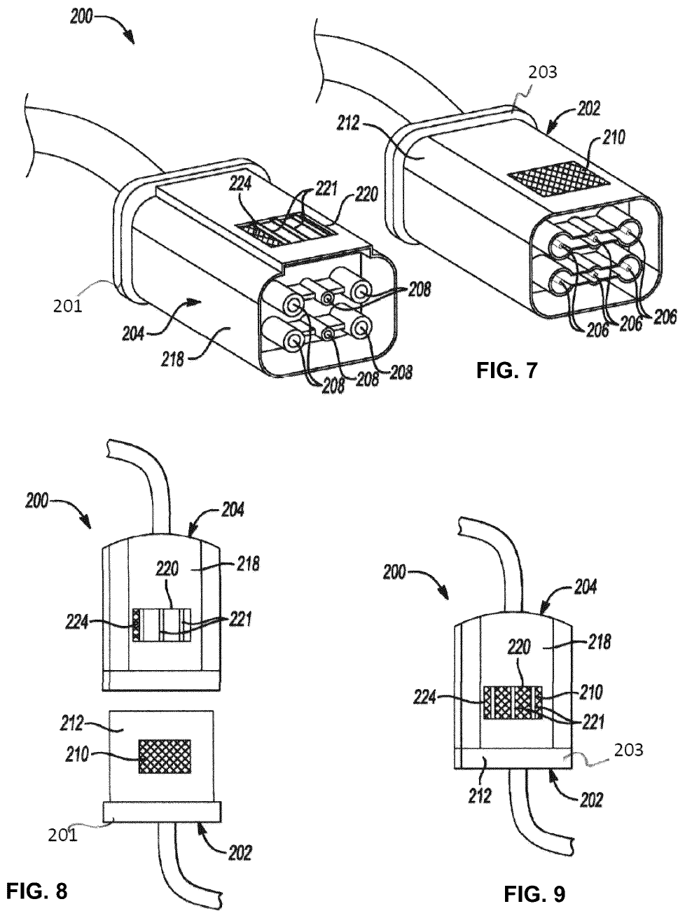

An inverter system can include several components that can incorporate a polymer composition as disclosed including, without limitation, the EMI filter apparatus 325, e.g., as a housing and/or internal support structures, an EMI filter card 340, the bus bars 310, as well as connectors employed within the system. For example, an electrical connector that includes the polymer composition as described herein may be employed in an inverter system as in FIG. 7 or within another portion of an electric vehicle. An electrical connector can in general include a first connector portion that contains at least one electrical contact and an insulating member that surrounds at least a portion of the connector portion. The insulating member may contain the polymer composition of the present invention. The first connector portion may be configured to mate with an opposing second connector portion that contains a receptacle for receiving the electrical contact. In such embodiments, the second connector portion may contain at least one receptacle configured to receive the electrical contact of the first connector portion and an insulating member that surrounds at least a portion of the second connector portion. The insulating member of the second connector portion may also contain the polymer composition of the present invention.

Referring to FIG. 7, FIG. 8, and FIG. 9, one particular embodiment of a connector 200 is shown for use in an electric vehicle, e.g., in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first insulator member 212 may extend from a base 203 of the first connecting portion 202 to surround the pins 206, and similarly, a second insulator member 218 may extend from a base 201 of the second connecting portion 204 to surround the receptacles 208. In certain cases, the periphery of the first insulator member 212 may extend beyond an end of the electrical pins 203 and the periphery of the second insulator member 218 may extend beyond an end of the receptacles 208. The base 203 and/or the first insulator member 212 of the first connector portion 202, as well as the base 201 and/or the second insulator member 218 of the second connector portion 204, may be formed from the polymer composition of the present invention.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

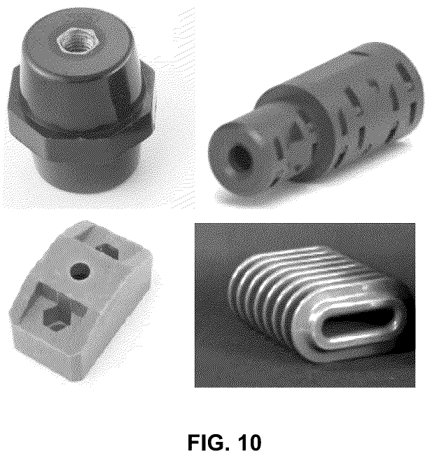

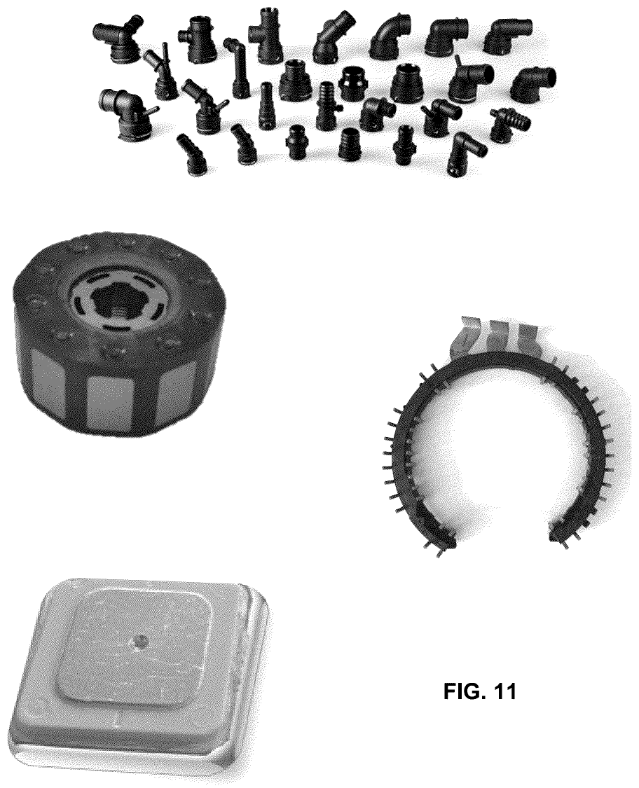

FIG. 10 and FIG. 11 illustrate yet other examples of components that may employ the polymer composition of the present invention, such as spacers, connectors, insulators and supports as shown in FIG. 10 and that can be formed from the polymer composition. Components as may incorporate a polymer composition illustrated in FIG. 11 include quick connects, tees, and interconnectors, a plurality of which are illustrated at the top of FIG. 11; brushless direct current motors (middle left of FIG. 11), e.g., sealing rings, housings, supports, etc. of a motor; guide rails (middle right of FIG. 11, also illustrating additional examples of busbars in the image); and battery sealing rings (bottom of FIG. 11).

Systems that can employ the polymer composition of the present invention are in no way limited to only electrical systems. For example, a thermal management system can also beneficially incorporate the polymer composition. A thermal management system of an electric vehicle can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

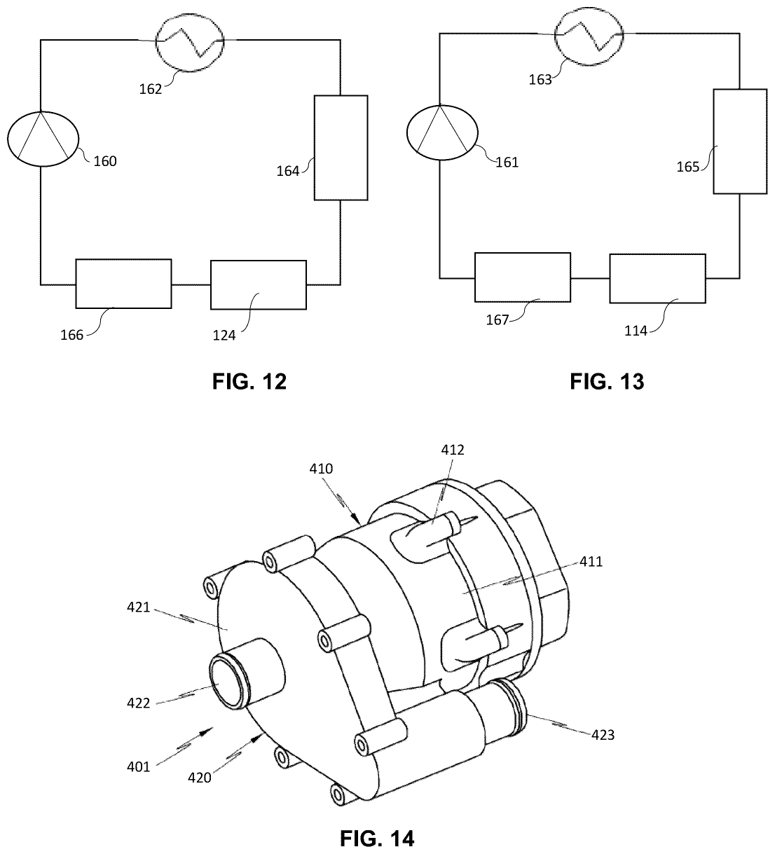

By way of example, FIG. 12 illustrates a first temperature control loop and FIG. 13 illustrates a second temperature control loop as may be found in electric vehicles, each of which designed for different subsystems and each of which including one or more components that can employ a polymer compositions of the invention. By way of example, a first temperature control loop in a typical electric vehicle (FIG. 12) can include a heat transfer medium (e.g., water, coolant, or a mixtures thereof) that is pumped through the loop via a suitable pump 160, e.g., an electric pump, and cooled via heat transfer with a refrigerant in a heat exchanger 162 (e.g., an energy storage system (ESS) heat exchanger) as well as a radiator/reservoir 164. Additionally, the loop can include a heater 166 e.g., a positive temperature coefficient (PTC) heater, which can ensure that the temperature of the system can be maintained within its preferred operating range regardless of the ambient temperature, and the battery assembly 124. A second temperature control loop (FIG. 13) can also include a heat transfer medium that can be the same or differ from the heat transfer medium of another subsystem. The heat transfer medium of the second temperature control loop can be pumped through the loop with a suitable pump 161, a heat exchanger 162, and a radiator reservoir 165. A high temperature control loop can be utilized in cooling the power electronics 167 as well as the electric machines 114 of the vehicle.

One example of a component of a heat management system as may incorporate the polymer composition of the invention is a coolant pump, e.g., an electric pump, an example of which is illustrated in FIG. 14. As shown, the electric pump 401 includes an electric motor 410 as a drive source and a hydraulic portion 420 for generating coolant suction and discharge forces. The motor 410 and associated components are retained with in the motor housing 411. The hydraulic portion 420 includes a volute casing 421 that generally includes a spiral flow space, an inlet 422, and outlet 423, and an impeller (not shown) rotated by the electric motor 410. The pump 401 has an interface including a mechanical seal (not shown), for sealing and separating the water flow space and the motor chamber. Generally, a mounting portion 412 is provided on the motor housing 411 to mount the pump 401 in the vehicle. Components of the electric pump 401 such as housings, casings, interfaces, etc. can incorporate the polymer composition of the invention.

The present invention may be better understood with reference to the following examples.

### Test Methods

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Hydrolytic Testing: An autoclave with a 4-liter capacity may be used to conduct high temperature hydrolysis testing. The autoclave contains an immersion heater and a temperature control system. The autoclave is initially filled with a solution containing 50 vol. % deionized water and 50 vol. % ethylene glycol. Samples having a volume of 7.5 liters are then fully immersed into the solution. The autoclave is closed and the solution is heated to 135° C., which results in an internal pressure of about 2-3 bars. After testing for 1,000 hours, the autoclave is cooled to room temperature (about 23° C.), the pressure is released, and the set of tensile bars is withdrawn for further testing.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more |
| | than 10 seconds after either test flame application. |
| | Total flaming combustion time must not exceed 50 seconds for |
| | each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 30 seconds after removal of the test flame. |
| V-1 | Specimens must not burn with flaming combustion for more |
| | than 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 60 seconds after removal of the test flame. |
| V-2 | Specimens must not burn with flaming combustion for more |
| | than 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

### Comparative Examples 1-2

Comparative Examples 1-2 were melt mixed using a 32 mm Coperion co-rotating, fully-intermeshing, twin-screw extruder and include various concentrations of a polyarylene sulfide, glass fibers, silane coupling agent, nucleating agent, black pigment masterbatch, and lubricant (Glycolube). The glass fibers were E-glass fibers obtained from Jushi Glass fibers (fiber diameter of 10 micrometers).

| | |
|---|---|
| Comp. Ex. 1 | Comp. Ex. 2 |

| | Wt. % | Parts | Wt. % | Parts |
|---|---|---|---|---|
| PPS | 56.71 | 100 | 56.86 | 100 |
| Silane Coupling Agent | 0.34 | 0.6 | 0.34 | 0.6 |
| Glass Fibers | 40.00 | 70.5 | 40.00 | 70.3 |
| Lubricant | 0.30 | 0.5 | 0.30 | 0.5 |
| Nucleating Agent | 0.15 | 0.3 | — | — |
| Black Masterbatch | 2.50 | 4.4 | 2.50 | 4.4 |

Once formed, the resulting compositions were then injected molded and tested for various properties as described above. The results are set forth below.

| | Comp. Ex. 1 | Comp. Ex. 2 |
|---|---|---|
| Tensile Modulus (MPa) | 16,534 | 15,520 |
| Initial Tensile Strength (MPa) | 210 | 191 |
| Aged Tensile Strength after Hydrolytic | 114 | 110 |
| Testing (MPa) | | |
| Initial Tensile Elongation at Break (%) | 1.66 | 1.80 |
| Aged Tensile Elongation at Break After | 1.02 | 0.97 |
| Hydrolytic Testing (%) | | |
| Flexural Modulus (MPa) | 16,284 | 14,841 |
| Flexural Strength (%) | 303 | 269 |
| Initial Charpy Notched (kJ/m²) | 11.4 | 7.6 |
| Aged Charpy Notched after | 3.4 | 3.0 |
| Hydrolytic Testing (kJ/m²) | | |
| DTUL at 1.8 MPa (° C.) | 272 | 267 |

### EXAMPLES 1-2

Examples 1-2 were melt mixed using a 32 mm Coperion co-rotating, fully-intermeshing, twin-screw extruder and include various concentrations of a polyarylene sulfide, glass fibers, silane coupling agent, nucleating agent, and lubricant (Glycolube). The glass fibers were E-CR glass fibers obtained from 3B under the name “DS 8800-11P” (average fiber diameter of 11 μm).

| | Ex. 1 | | Ex. 2 | | Ex. 3 | |
|---|---|---|---|---|---|---|
| | Wt. % | Parts | Wt. % | Parts | Wt. % | Parts |
| PPS | 56.71 | 100 | 56.86 | 100 | 56.45 | 100 |
| Silane Coupling Agent | 0.34 | 0.6 | 0.34 | 0.6 | 0.75 | 1.3 |
| Glass Fibers | 40.00 | 70.5 | 40.00 | 70.3 | 40.00 | 70.9 |
| Lubricant | 0.30 | 0.5 | 0.30 | 0.5 | 0.30 | 0.5 |
| Nucleating Agent | 0.15 | 0.3 | — | — | — | — |
| Black Masterbatch | 2.50 | 4.4 | 2.50 | 4.4 | 2.50 | 4.4 |

Once formed, the resulting compositions were then injected molded and tested for various properties as described above. The results are set forth below.

| | Ex. 1 | Ex. 2 | Ex. 3 |
|---|---|---|---|
| Tensile Modulus (MPa) | 14,495 | 14,785 | 15,674 |
| Initial Tensile Strength (MPa) | 185 | 187 | 182 |
| Aged Tensile Strength after | 120 | 173 | 177 |
| Hydrolytic Testing (MPa) | | | |
| Initial Tensile Elongation at | 1.9 | 1.8 | 1.89 |
| Break (%) | | | |
| Aged Tensile Elongation After | 1.1 | 1.5 | 1.5 |
| Hydrolytic Testing (%) | | | |
| Flexural Modulus (MPa) | 14,151 | 14,395 | 14,151 |
| Flexural Strength (%) | 269 | 271 | 269 |
| Initial Charpy Notched (kJ/m²) | 8.0 | 8.6 | 7.5 |
| Aged Charpy Notched after | 3.8 | 7.0 | 6.6 |
| Hydrolytic Testing (kJ/m²) | | | |
| DTUL at 1.8 MPa (° C.) | 266.3 | 268 | 267 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising 100 parts by weight of a polymer matrix that includes at least one polyarylene sulfide and from about 30 parts by weight to about 120 parts by weight of inorganic fibers, wherein the polymer composition exhibits an initial tensile strength and an aged tensile strength after exposure to a solution containing 50 vol. % deionized water and 50 vol. % of ethylene glycol at a temperature of 135° C. for 1,000 hours, wherein the ratio of the aged tensile strength to the initial tensile strength is about 0.8 or more, wherein the initial tensile strength and the aged tensile strength are determined at a temperature of 23° C. in accordance with ISO 527:2019.

2. The polymer composition of claim 1, wherein the aged tensile strength is from about 125 to about 250 MPa.

3. The polymer composition of claim 1, wherein the polymer composition exhibits an initial tensile elongation and an aged tensile elongation after exposure to a solution containing 50 vol. % deionized water and 50 vol. % of ethylene glycol at a temperature of 135° C. for 1,000 hours, wherein the ratio of the aged tensile elongation to the initial tensile elongation is about 0.7 or more, wherein the initial tensile elongation and the aged tensile elongation are determined at a temperature of 23° C. in accordance with ISO 527:2019.

4. The polymer composition of claim 3, wherein the aged tensile elongation is from about 1.2% to about 5%.

5. The polymer composition of claim 1, wherein the polymer composition exhibits an initial notched Charpy impact strength and an aged notched Charpy impact strength after exposure to a solution containing 50 vol. % deionized water and 50 vol. % of ethylene glycol at a temperature of 135° C. for 1,000 hours, wherein the ratio of the aged notched Charpy impact strength to the initial notched Charpy impact strength is about 0.6 or more, wherein the initial notched Charpy impact strength and the aged notched Charpy impact strength are determined at a temperature of 23° C. in accordance with ISO 179:2020.

6. The polymer composition of claim 5, wherein the aged notched Charpy impact strength is from about about 5 to about 15 kJ/m².

7. The polymer composition of claim 1, wherein the polymer matrix constitutes from about 40 wt. % to about 90 wt. % of the polymer composition.

8. The polymer composition of claim 1, wherein the polyarylene sulfide is a polyphenylene sulfide.

9. The polymer composition of claim 8, wherein the polyarylene sulfide is a linear polyphenylene sulfide.

10. The polymer composition of claim 1, wherein the inorganic fibers have a diameter of from about 5 to about 40 micrometers.

11. The polymer composition of claim 1, wherein the inorganic fibers include glass fibers.

12. The polymer composition of claim 11, wherein the glass fibers are generally free of boron.

13. The polymer composition of claim 11, wherein the glass fibers are E-CR glass fibers.

14. The polymer composition of claim 11, wherein the glass fibers contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, and magnesium oxide in an amount of from about 8.5 wt. % to about 12.5 wt. %.

15. The polymer composition of claim 1, wherein the inorganic fibers are coated with a sizing composition.

16. The polymer composition of claim 15, wherein the sizing composition contains an alkoxysilane.

17. The polymer composition of claim 16, wherein the alkoxysilane includes an aminotrialkoxysilane, aminodialkoxysilane, or a combination thereof.

18. The polymer composition of claim 15, wherein the sizing composition contains a functionalized compound.

19. The polymer composition of claim 18, wherein the functionalized compound includes an anhydride- and/or carboxylic-functionalized polymer, epoxy-functionalized polymer, or a combination thereof.

20. The polymer composition of claim 18, wherein the functionalized compound includes a blocked isocyanate.

21. The polymer composition of claim 20, wherein the blocked isocyanate is capable of becoming deblocked at a temperature of from about 90° C. to about 210° C.

22. The polymer composition of claim 20, wherein the blocked isocyanate includes a blocked cycloaliphatic polyisocyanate.

23. The polymer composition of claim 15, wherein the sizing composition contains a film-forming agent.

24. The polymer composition of claim 15, wherein the coated inorganic fibers have a moisture content of about 0.5 wt. % or less.

25. The polymer composition of claim 1, further comprising from about 0.1 to about 8 parts by weight of an organosilane compound.

26. An electric vehicle comprising a powertrain that includes at least one electric propulsion source and a transmission that is connected to the propulsion source via at least one power electronics module, wherein the electric vehicle comprises the polymer composition of claim 1.

27. The electric vehicle of claim 26, wherein the electric vehicle comprises an electrical component comprising the polymer composition.

28. The electric vehicle of claim 27, wherein the electrical component comprises a busbar, current sensor, inverter filter, electrical connector, a brushless direct current motor, a guide ring, a battery cell sealing ring, or a combination thereof.

29. The electric vehicle of claim 27, wherein the electrical component comprises a quick connectors, a tee, an interconnector, or a combination thereof.

30. The electric vehicle of claim 26, wherein the electric vehicle comprises a thermal management system component comprising the polymer composition.

31. The electric vehicle of claim 30, wherein the thermal management system component comprises a coolant pump.
